(19) United States
(12) Patent Application Publication
(10) Pub. No.: US 2026/0170960 A1
(43) Pub. Date: Jun. 18, 2026

(54) INTELLIGENT TRANSPORT SYSTEM AND METHOD FOR IMPROVING ROAD SAFETY AND METHOD AND AN ELECTRONIC DEVICE FOR A ROAD USER

(71) Applicant: Volkswagen Aktiengesellschaft, Wolfsburg (DE)

(72) Inventors: Patrick Diekhake, Wolfsburg (DE); Razvan Racu, Wolfsburg (DE)

(21) Appl. No.: 19/406,525

(22) Filed: Dec. 2, 2025

(30) Foreign Application Priority Data
Dec. 16, 2024 (EP) 24220206.7

(51) Int. Cl. G08G 1/16; G08G 1/01

(52) U.S. Cl. CPC G08G 1/164; G08G 1/0116; G08G 1/0125; G08G 1/0141; G08G 1/0145; G08G 1/166

(57) ABSTRACT

An intelligent transport system for improving road safety. A road infrastructure unit and/or a first road user detects an event in its environment that represents a threat to road safety and broadcasts a direct communication signal containing information associated with the event. A second road user receives the direct communication signal and uploads at least part of the event information to a backend server. A third road user downloads the uploaded event information from the backend server, determines a relevance of the event based on the information, and outputs the determined relevance or prepares a countermeasure. The disclosure also relates to methods performed by the road users, an electronic device configured to execute the methods, and computer-readable media storing instructions for performing the methods.

### RELATED APPLICATIONS

The present application claims priority to European Patent App. No. 24220206.7,filed Dec. 16, 2024 to Diekhake et al., the contents of which is incorporated by reference in its entirety herein.

### TECHNICAL FIELD

The present disclosure relates to an intelligent transport system and to a method for improving road safety. In some examples, the present disclosure also pertains to a method and an electronic device for a road user. Furthermore, the present disclosure relates to computer programs.

### BACKGROUND

Vehicle-to-Everything (V2X) communication technologies are expected to become key pillars for increasing safety and efficiency in road transportation. Various types of V2X technologies exist and are used, among other things, to exchange hazard-related information.

One example of V2X communication is direct communication (also referred to as ad-hoc communication), in which information is transmitted only between vehicles located in the immediate vicinity—typically within a radius of up to approximately 1 km—of the transmitter of the communication signal. These communication signals and their associated data can only be received by vehicles within this radius if those vehicles support the corresponding direct communication technology. If the data received is not considered relevant to the receiving vehicle, the receiving vehicle generally discards the data.

Another example of inter-vehicle communication is network-based communication. In network-based implementations, vehicles are connected to a remote network, such as a cloud server, and exchange data via the network. A vehicle that detects a particular event may upload information about the event to the cloud server, and other vehicles can subsequently download the event information to be alerted to the detected situation.

Document FR 3 100 203 A1 relates to a method and a device for warning a vehicle. Information representative of road conditions in a determined area of a road environment is received and compared with a history of information representative of road conditions associated with that determined area. An alert is output based on the result of the comparison.

Document EP 4 307 269 A1 suggests a Cooperative Intelligent Transport System (C-ITS). In response to detecting a situation involving an object located within an area monitored by the ITS, a Collective Perception Message (CPM) is generated and transmitted. The CPM includes a reference to the object and an indication that the object is involved in the detected situation.

Document WO 2015/133181 A1 pertains to a communication apparatus, a communication control method, and a corresponding program. A reception unit receives messages transmitted from multiple transmission-source apparatuses, including information indicating message type and identifiers of the respective transmission sources. A control unit executes, based on the types of messages received by the reception unit, a transmission operation to transmit a representative message indicating the same information as particular messages received from different transmission-source apparatuses identified by different respective identifiers.

Document US 2013/0325940 A1 discloses a geomessaging server and a geomessaging client for use in a cooperative intelligent transportation system. The server sends an event notification message via an infrastructure-based wireless communication network to a geomessaging client associated with a vehicle located within a targeted one of multiple defined geographical areas. The message indicates the occurrence of an event pertinent to travel conditions in the targeted area. The server also generates a message-relay request that solicits the geomessaging client to relay the message to other vehicles within the vehicle's vicinity via a vehicular ad-hoc wireless communication network. The server then transmits the request to the client via the infrastructure-based network. In some implementations, the geomessaging client relays the message responsive to receiving the request, enabling other vehicles to receive the event notification message even if they are not directly connected to the server.

### SUMMARY

In direct communication applications, events are broadcast locally and received only within a limited range, such as in the immediate vicinity of the broadcaster. Although this allows receiving vehicles to collect external event information, such vehicles typically discard any events deemed irrelevant to them. In network-based applications, the emphasis is generally on downloading events. Only events detected by a given vehicle itself tend to be uploaded. However, there is a continuing need to further improve road safety.

Some aspects of the present disclosure address this need through an intelligent transport system and a method for improving road safety, as well as an electronic device and method for a road user and associated computer programs. Additional advantageous configurations and features will become apparent from the dependent claims and the following description.

In some examples, an intelligent transport system (ITS) is disclosed for improving road safety. ITSs may utilize various technologies to monitor, evaluate, and manage transport systems to enhance safety and efficiency, for example by improving traffic flow. They may link transportation infrastructure and vehicles through information and communication technologies, computers, electronic systems, and sensors.

In some examples, the ITS comprises a backend server, road infrastructure and/or a first road user, a second road user, and a third road user. Each road user includes an electronic device. The backend server includes at least one remotely located server accessible from any location at any time through a secure and protected Internet connection. In other words, the backend server represents a cloud-based storage and processing environment external to the user's physical location, to which data, applications, and computing operations may be transferred and processed.

In some examples, the road infrastructure may be configured as a roadside unit (RSU). An RSU is a device used in ITS and connected-vehicle environments and may be positioned along roads or highways to facilitate communication between vehicles and transportation infrastructure, such as for enabling Vehicle-to-Infrastructure (V2I) and V2X communication. The RSU includes a communication module configured to exchange information with vehicles in the vicinity of the RSU. For example, the communication module may support Dedicated Short-Range Communication (DSRC) or Cellular Vehicle-to-Everything (C-V2X) communication.

In some examples, a method is disclosed for improving road safety. The method may be implemented using an ITS such as any of those described herein. The features and advantages of the ITS can be applied analogously to the method for improving road safety.

In some examples, an electronic device is disclosed that is configured to perform any of the methods for a road user described herein. The electronic device may be implemented as part of a control unit of a vehicle. The control unit may be configured to perform the above-mentioned method for a road user. The features and advantages of the method for a road user apply analogously to the electronic device and to the control unit.

In some examples, a road user comprising the electronic device configured to perform the above-mentioned method for a road user is disclosed. The road user may be a vehicle including a V2X communication module and the above-mentioned control unit. The features and advantages of the electronic device apply analogously to the road user.

Any of the electronic devices and/or control units described herein may be implemented using electrical or electronic components (hardware) or firmware (e.g., ASIC). Additionally or alternatively, the functionality of the electronic devices and/or control units may be realized by executing an appropriate computer program (software). Individual components for providing specific functionalities may be designed as separate integrated circuits or may be arranged on a common integrated circuit.

The individual components of the electronic devices and/or control units may also be realized as one or more processes executed by one or more processors of one or more electronic computing devices. These computing devices may be configured to cooperate with one another to implement the functionalities disclosed herein. Instructions of the computer programs may be stored in memory devices, such as RAM elements. Alternatively or additionally, the computer programs may be stored in non-volatile storage media, such as CD-ROMs, flash memory, or similar storage devices.

It will be apparent to a skilled person that the functionalities of multiple computing units (data processing devices) may be combined into a single device, or that the functionality of a single data processing device may be distributed across multiple devices, to implement the functionality of the electronic devices and/or control units.

In some examples, a computer program comprising instructions is disclosed which, when executed by a computer such as an electronic device and/or control unit, causes the computer to perform any of the methods described in the present disclosure, including methods for improving road safety and/or methods for a road user.

Additional preferred embodiments of the present disclosure result from the further features described in the dependent claims.

The various embodiments described herein may be combined with one another in advantageous ways unless explicitly stated otherwise in an individual instance.

### BRIEF DESCRIPTION OF THE DRAWINGS

Various features and advantages of the present disclosure will become apparent to those skilled in the art from the following detailed description of examples, when read in light of the accompanying drawings. It shows:

FIG. 1 schematically illustrates an intelligent transport system in an exemplary traffic situation, according to some aspects of the present disclosure.

FIG. 2 schematically illustrates a flow chart of a method for improving road safety, according to some aspects of the present disclosure.

FIG. 3 schematically illustrates an electronic device for a road user, according to some aspects of the present disclosure.

### DETAILED DESCRIPTION

In the following description, recurring or similar features in this and subsequent figures are provided with the same reference numerals, and repeated explanations are omitted.

A first electronic device of a first road user and/or the road infrastructure is configured to detect an event in its environment that represents a threat to road safety and to broadcast a first Road-user-to-Everything (R2X) and/or Infrastructure-to-Road-user (I2R) direct communication signal containing information associated with the detected event. In some examples, the first electronic device may include an R2X communication module, a sensor unit configured to at least partially scan the environment of the electronic device for events concerning a threat to road safety-such as at least one camera or a surround-view camera system-and a processor configured to detect such an event by processing data from the sensor unit. The processor may further be configured to broadcast an R2X and/or an I2R direct communication signal that includes information associated with the detected event using the R2X communication module. The R2X and/or I2R direct communication signal may include an event type, an event position, an event detection time, and/or an indication of the detection means used (e.g., a front or rear camera or a surround-view camera system).

Direct communication enables communication between road users and/or road infrastructure without routing the communication through an external server or communication node. For example, some or all road users may each be vehicles incorporating the electronic device as part of a control unit and associated sensors. In this case, communication may take place using Vehicle-to-Everything (V2X) and/or Infrastructure-to-Vehicle (I2V) technologies. V2X communication enables information exchange between vehicles and other nodes, such as through Vehicle-to-Vehicle (V2V), Vehicle-to-Infrastructure (V2I), Vehicle-to-Network (V2N), and/or Vehicle-to-Pedestrian (V2P) communication.

A second electronic device of a second road user is configured to receive the R2X and/or I2R direct communication signal broadcast by the first road user and/or the road infrastructure and to upload at least a portion (e.g., all) of the information associated with the detected event to the backend server. The second electronic device is thus configured for data exchange with the backend server. Rather than discarding the received information based on spatial or temporal irrelevance, the second electronic device uploads the received information, thereby enriching the backend server's database. The uploaded data may be relevant to other road users, and uploading information gathered through direct communication can enhance road safety by improving the accuracy and completeness of environmental knowledge available to connected vehicles and infrastructure.

A third electronic device of a third road user is configured to download at least a portion of the information associated with the detected event from the backend server and to determine a current and/or future relevance of the detected event for the third road user based on that information. The third electronic device is further configured to output the determined relevance and/or to prepare a countermeasure based on the determined relevance. For example, the downloaded information may include an event type, event position, detection time, detection means, and/or a warning associated with the detected event. Some or all of this information may be used to assess relevance. A warning may be output if the determined relevance exceeds a predetermined threshold, allowing the third road user to react appropriately or enabling automated systems to undertake countermeasures. This may reduce the risk of a crash and improve overall road safety for the third road user and surrounding road users.

In some examples, the threat to road safety may relate to a road hazard, a driving environment, and/or a traffic condition in the environment of the road infrastructure and/or the first electronic device. The threat may, for example, relate to abnormal traffic conditions, where “abnormal” indicates significant deviation from average or expected conditions, which may be calculated based on historical data. Examples of road hazards include slow vehicles, wrong-way drivers, pedestrians, animals, obstacles on the road, or stationary vehicles (e.g., breakdowns or illegal parking). Examples of driving environments include weather conditions such as snow, rain, sun glare, or icy roads. Examples of traffic conditions include traffic jams, roadworks, accidents, or passing emergency vehicles. The particular threat may be used to determine the event type, which may be included in the R2X and/or I2R direct communication signal so that other road users can evaluate relevance and prepare countermeasures.

In some examples, the first electronic device and/or the road infrastructure may not be connected to, or may not support communication with, the backend server. As a result, they are unable to upload detected events to the backend server directly. By uploading the detected event via the second electronic device, the event information is not lost due to lack of connectivity or due to irrelevance for a particular device and may still be made available to warn other road users.

In some examples, the second electronic device may be configured to determine a relevance of the detected event for the second road user based on the received information and to output the determined relevance and/or prepare a countermeasure prior to uploading the information to the backend server. Thus, the second electronic device may react to the detected event before initiating the upload process, allowing earlier mitigation of risk for the second road user.

In some examples, the second electronic device may be configured to upload the information associated with the detected event irrespective of the determined relevance. That is, the second electronic device may upload the information whether the relevance is low or high. Even when the information is of low relevance to the second road user, it is still provided to the backend server for use by others. This enriches the backend server's database with valuable information, improving its accuracy and helping reduce road-user crashes and associated fatalities.

In some examples, the second electronic device may be configured to automatically upload the information associated with the detected event to the backend server without requiring user interaction. Compared to manual third-party cloud entries-whose position data may be inaccurate due to time delays-automatically uploaded information has a high level of accuracy and reliability. Because of this higher quality, such events may not require additional confirmation by the backend server, reducing computational load during database enrichment.

In some examples, the second electronic device may be configured to delete the information associated with the detected event once the upload to the backend server has been successfully completed or after a predetermined time has elapsed since detection of the event or reception of the R2X and/or I2R direct communication signal. Otherwise, the information may not be deleted. Deleting the information after successful upload reduces memory requirements in the electronic device. The predetermined time may also be adjusted based on event type; for example, some events (e.g., weather conditions or wrong-way drivers, pedestrians, obstacles, emergency braking, or safety-system intervention) may be short-duration events, whereas others (e.g., roadworks or stationary vehicles) may persist longer.

In some examples, the broadcast R2X and/or I2R direct communication signal may include or consist of a Decentralized Environmental Notification Message (DENM) associated with the detected event. A DENM is defined in ETSI standard EN 302 637-3 V 1.2.2 (2014-11) and includes information about both the transmitting road user and the event, such as a hazard area, for warning others. A DENM may be transmitted as a standalone message, allowing the use of well-established, standardized communication protocols and improving the likelihood that receiving road users can process the information appropriately.

In some examples, the second electronic device may be further configured to broadcast a second R2X direct communication signal including a Cooperative Awareness Message (CAM) to indicate the presence of the second road user to nearby road users and/or road infrastructure. The road infrastructure and/or the first electronic device may be further configured to receive this CAM signal and to broadcast or repeatedly broadcast the R2X and/or I2R direct communication signal containing the event information in response. A CAM is generated periodically at a frequency controlled by the originating electronic device and may include speed, position, and steering or orientation information of the vehicle, as defined in ETSI standard EN 302 637-2 V 1.4.1 (2019-04). Because direct communication signals do not include acknowledgment responses, retransmitting the event information in response to a CAM increases the likelihood that the second road user remains within communication range and successfully receives the information for upload to the backend server.

In some examples, the first R2X and/or I2R direct communication signal and/or the second R2X direct communication signal may be based on connectionless communication, while the upload by the second road user and/or the download by the third road user from the backend server may be based on connection-oriented communication. Using both communication types-connectionless direct communication and connection-oriented cloud communication-enables efficient exchange of event information and improves the robustness of event dissemination.

During operation of the method, an event concerning a threat to road safety in the environment of the road infrastructure and/or a first road user is detected, for example by the first electronic device of the first road user and/or the road infrastructure of the ITS.

In a further step of the method, an R2X and/or an I2R direct communication signal including information associated with the detected event is broadcast by the road infrastructure and/or the first road user.

In a subsequent step, the R2X and/or I2R direct communication signal is received by a second road user.

Based on the information associated with the detected event, the second road user determines a relevance of the detected event for the second road user.

The second road user then outputs the determined relevance and/or prepares a countermeasure based on the determined relevance of the detected event before initiating an upload of the information associated with the detected event to the backend server.

In a further step, at least a portion of the information associated with the detected event is uploaded from the second road user to the backend server.

In a further step of the method, at least the portion of the information associated with the detected event is downloaded from the backend server by a third road user.

Based on the downloaded information, the third road user determines a relevance of the detected event for the third road user.

The third road user then outputs the determined relevance and/or prepares a countermeasure based on the determined relevance of the detected event.

In some examples of the present disclosure, a method for a road user is also provided. The features and advantages described for the method for improving road safety apply analogously to the method for a road user.

In a step of the method for a road user, an R2X and/or an I2R direct communication signal including information associated with an event detected by another road user and/or the road infrastructure is received by the road user.

Based on the information associated with the detected event, the road user (e.g., the second road user) determines a relevance of the detected event for the road user.

The road user then outputs the determined relevance and/or prepares a countermeasure based on the determined relevance of the detected event before initiating an upload of the information associated with the detected event to the backend server.

In a further step of the method for a road user, at least a portion of the information associated with the detected event is uploaded from the road user to the backend server.

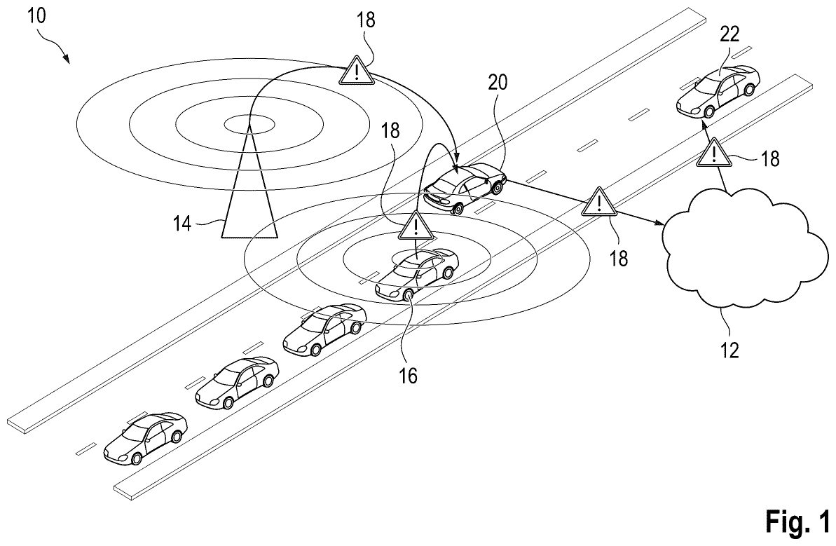

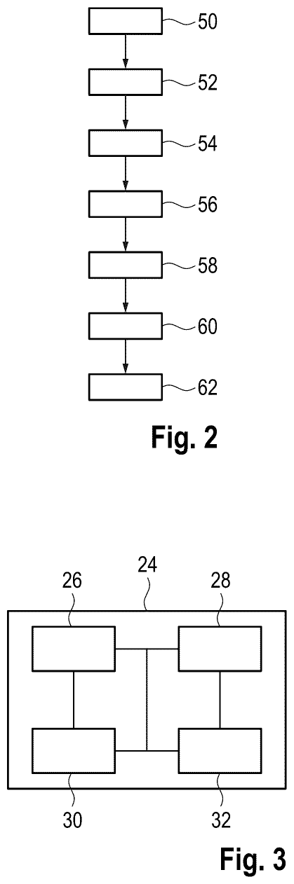

FIG. 1 schematically illustrates an intelligent transport system (ITS) 10 for improving road safety in an exemplary traffic situation according to some aspects of the present disclosure. A method for improving road safety and a method for a road user 20 are described with reference to FIG. 2. The traffic situation shown in FIG. 1 represents merely one example among many potential scenarios, and the present disclosure is not limited to the illustrated configuration.

The ITS 10 includes a backend server 12, a road infrastructure 14, a first road user 16, a second road user 20, and a third road user 22. However, the ITS 10 is not limited to this arrangement. For example, the road infrastructure 14 or the first road user 16 may be omitted in other implementations. Each of the road users 16, 20, and 22 includes an electronic device 24, which is described in greater detail with reference to FIG. 3. In the embodiment shown in FIG. 1, the road users 16, 20, and 22 are implemented as vehicles. However, at least one or more of the road users may instead be pedestrians, cyclists, or any other type of road user carrying the electronic device 24.

The backend server 12 is depicted as a cloud to indicate that it provides cloud-based applications. In some examples, the backend server 12 includes multiple remotely located servers accessible from any location at any time via a secure and protected Internet connection. Thus, the backend server 12 functions as a cloud-based storage and processing environment external to the locations of the road users 16, 20, and 22, enabling data, applications, and computation to be offloaded and processed remotely.

The road infrastructure 14 is implemented as a roadside unit (RSU). In the example shown in FIG. 1, the road infrastructure 14 is positioned alongside a road or highway to facilitate communication between road users and transportation infrastructure, such as for enabling Vehicle-to-Infrastructure (V2I) and Vehicle-to-Everything (V2X) communication. The transportation infrastructure may include sensors configured to detect traffic conditions and/or the status of traffic lights. The road infrastructure 14 includes a communication module configured to exchange information with nearby road users 16, 20, and 22 via direct communication.

In the example shown in FIG. 1, the first road user 16 represents a vehicle approaching the end of a traffic jam, illustrated by a queue of standing vehicles. This situation requires the first road user 16 to slow down to avoid a rear-end collision. However, when another road user—such as the third road user 22 traveling in the same lane but at a greater distance—is unaware of the traffic jam and does not pay sufficient attention, emergency braking may be required to avoid an accident. Such emergency braking can surprise following road users, creating a significant risk of collision.

In the example of FIG. 1, the road infrastructure 14 and the first road user 16 are not connected to the backend server 12, for example due to temporary lack of connectivity or lack of communication capability. In contrast, the second road user 20 and the third road user 22 are connected to the backend server 12. As a result, events detected by the road infrastructure 14 and the first road user 16 cannot be directly uploaded to the backend server 12 for retrieval by other road users such as the third road user 22.

The road infrastructure 14 is configured to detect an event 18 in its environment that constitutes a threat to road safety—such as the traffic jam shown in FIG. 1—a nd to broadcast an Infrastructure-to-Road-user (I2R) direct communication signal containing information associated with the detected event 18. Additionally, the electronic device 24 of the first road user 16 is configured to detect the event 18 and to broadcast a Road-user-to-Everything (R2X) direct communication signal including information associated with the detected event 18. These direct communication signals have a limited transmission range, such that only road users within the immediate vicinity (e.g., within approximately 1 km) can receive them. In the example shown, the second road user 20—traveling in the opposite lane—is within range, while the third road user 22 is too far away to receive the direct communication signals.

The electronic device 24 of the second road user 20 is configured to receive the R2X and I2R direct communication signals from the road infrastructure 14 and the first road user 16 and to process the information associated with the detected event 18. Rather than discarding the information due to irrelevance to the second road user 20, the electronic device 24 uploads the received information to the backend server 12, thereby enriching its database. As illustrated in FIG. 1, this uploaded information is relevant to other road users, such as the third road user 22. Uploading event information obtained through direct communication signals enhances road safety by enabling the backend server 12 to maintain a more complete and accurate representation of environmental conditions surrounding road users 16 and road infrastructure 14. Advantageously, this can reduce the number of road-user collisions and associated fatalities.

The electronic device 24 of the third road user 22 is configured to download the information associated with the detected event 18 from the backend server 12 and to determine a relevance of the detected event 18 for the third road user 22 based on the downloaded information. The electronic device 24 may output the determined relevance to the driver and/or prepare a countermeasure based on the determined relevance. For example, the electronic device 24 of the third road user 22 may determine that a smooth deceleration is required to reduce the risk of a rear-end collision with the first road user 16 and may present an alert to the driver. Accordingly, the risk of a crash involving the third road user 22 due to the event 18 can be reduced, thereby advantageously improving road safety for the third road user 22 as well as for following traffic.

FIG. 2 schematically illustrates a flow chart of a method for improving road safety according to some aspects of the present disclosure, suitable for use with the ITS 10 shown in FIG. 1.

In a first step 50, an event 18 concerning a threat to road safety in the environment of the road infrastructure 14 and/or the first road user 16 is detected, for example by the electronic device 24 of the first road user 16 and/or by the road infrastructure 14.

In a second step 52, an R2X and/or an I2R direct communication signal including information associated with the detected event 18 is broadcast by the road infrastructure 14 and/or the first road user 16.

In a third step 54, the R2X and/or I2R direct communication signal is received by the second road user 20.

In a fourth step 56, at least a portion of the information associated with the detected event 18 is uploaded from the second road user 20 to the backend server 12.

In a fifth step 58, at least the portion of the information associated with the detected event 18 is downloaded from the backend server 12 by the third road user 22.

In a sixth step 60, the third road user 22 determines a relevance of the detected event 18 based on the information associated with the detected event 18.

In a seventh step 62, the third road user 22 outputs the determined relevance and/or prepares a countermeasure based on that relevance, for example through the electronic device 24 of the third road user 22.

The method steps associated with the second road user 20 may be considered a further method according to some aspects of the present disclosure. That is, FIG. 2 also schematically illustrates a flow chart of a method for a road user-specifically the second road user 20. This method for a road user includes steps 54 and 56.

FIG. 3 schematically illustrates an electronic device 24 for a road user, according to some aspects of the present disclosure. The electronic device 24 may correspond to the electronic device of the first road user 16; however, the present disclosure is not limited thereto. Any of the road users 16, 20, and 22 shown in FIG. 1 may include the electronic device 24 of FIG. 3.

The electronic device 24 includes an R2X communication module 26, a sensor unit 28 configured to at least partially scan the environment of the electronic device 24 for events 18 concerning a threat to road safety, a processor 30, and a memory 32. The sensor unit 28 may include at least one camera or a camera system comprising multiple cameras, such as a surround-view camera system. The processor 30 is configured to detect an event 18 in the environment by using the sensor unit 28 and processing corresponding sensor data, and to broadcast and/or receive an R2X direct communication signal containing information associated with the detected event 18 by using the R2X communication module 26. The R2X direct communication signal may include an event type, an event position, an event time of detection, and/or an indication of the detection means used to detect the event.

The direct communication between road users and/or road infrastructure, and communication with the backend server 12, may be based on exchanged radio frequency (RF) signals such as Bluetooth, Ultra-Wideband, Wireless-LAN, or 4G and/or 5G mobile telecommunication technologies. However, the present disclosure is not limited thereto.

### LIST OF REFERENCE SIGNS

10 intelligent transport system
12 backend server
14 road infrastructure
16 first road user
18 event concerning a threat to road safety
20 second road user
22 third road user
24 electronic device
26 communication module
28 sensor unit
30 processor
32 memory
50 first method step-detecting an event
52 second method step-broadcasting direct communication signal
54 third method step-receiving direct communication signal
56 fourth method step-uploading the detected event
58 fifth method step-downloading the detected event
60 sixth method step - determining relevance of the event
62 seventh method step-outputting the determined relevance

1. A system for improving road safety, comprising:
a backend server including at least one communication interface configured to receive uploaded information from road users and to provide corresponding information to requesting road users;
a road infrastructure and/or a first road user including a first electronic device, the road infrastructure and/or the first electronic device being configured to
detect an event in an environment of the road infrastructure and/or the first road user that concerns a threat to road safety and
broadcast a road-user-to-everything (R2X) direct communication signal and/or an infrastructure-to-road-user (I2R) direct communication signal that includes information associated with the detected event;
a second road user comprising a second electronic device configured to receive the R2X and/or the I2R direct communication signal and upload at least a portion of the information associated with the detected event to the backend server; and
a third road user comprising a third electronic device configured to
download at least the portion of the information associated with the detected event from the backend server,
determine a relevance of the detected event for the third road user based on the information associated with the detected event, and
output the determined relevance and/or prepare a countermeasure based on the determined relevance.

2. The system of claim 1, wherein the threat to road safety is related to a road hazard, a driving environment, and/or a traffic condition in the environment of the road infrastructure and/or the first electronic device.

3. The system of claim 1, wherein the first electronic device of the first road user and/or the road infrastructure is not connected to, or does not support communication with, the backend server.

4. The system of claim 1, wherein the second electronic device is further configured to determine a relevance of the detected event for the second road user based on the information associated with the detected event and to output the determined relevance and/or prepare a countermeasure based on the determined relevance of the detected event before uploading the information associated with the detected event to the backend server.

5. The system of claim 4, wherein the second electronic device is configured to upload the information associated with the detected event to the backend server irrespective of the determined relevance of the detected event for the second road user.

6. The system of claim 1, wherein the second electronic device is configured to automatically upload the information associated with the detected event to the backend server.

7. The system of claim 1, wherein the second electronic device is configured to delete the information associated with the detected event when the information has been successfully uploaded to the backend server or when a predetermined time has elapsed since detection of the event or reception of the R2X and/or the I2R direct communication signal.

8. The system of claim 1, wherein the R2X and/or the I2R direct communication signal includes or consists of a Decentralized Environmental Notification Message associated with the detected event.

9. The system of claim 1, wherein the second electronic device is further configured to broadcast a second R2X direct communication signal comprising a Cooperative Awareness Message for indicating a presence of the second road user to surrounding road users and/or the road infrastructure, and wherein the road infrastructure and/or the first electronic device is further configured to receive the second R2X direct communication signal and broadcast or repeatedly broadcast the R2X and/or the I2R direct communication signal comprising the information associated with the detected event in response to receiving the second R2X direct communication signal.

10. The system of claim 1, wherein the R2X and/or the I2R direct communication signal and/or the second R2X direct communication signal is based on connectionless communication, and wherein uploading by the second road user and/or downloading by the third road user from the backend server is based on connection-oriented communication.

11. A method for improving road safety, comprising:
detecting, by a road infrastructure or a first road user, an event concerning a threat to road safety in an environment of the road infrastructure or the first road user;
broadcasting, by the road infrastructure or the first road user, a road user to Everything (R2X) direct communication signal or an Infrastructure to road user (I2R) direct communication signal comprising information associated with the detected event;
receiving, by a second road user, the R2X or the I2R direct communication signal;
uploading, by the second road user, at least a part of the information associated with the detected event to a backend server;
downloading, by a third road user, the at least part of the information associated with the detected event from the backend server;
determining, by the third road user, a relevance of the detected event for the third road user based on the information associated with the detected event; and
outputting the determined relevance or preparing a countermeasure based on the determined relevance.

12. The method of claim 11, wherein the threat to road safety is related to a road hazard, a driving environment, or a traffic condition in the environment of the road infrastructure or the first road user.

13. The method of claim 12, wherein the road infrastructure or the first road user is not connected to, or does not support a communication with, the backend server.

14. The method of claim 13, further comprising determining, by the second road user, a relevance of the detected event for the second road user based on the information associated with the detected event, and outputting the determined relevance or preparing a countermeasure based on the determined relevance before the uploading to the backend server begins.

15. The method of claim 14, wherein the uploading to the backend server is performed irrespective of the determined relevance for the second road user.

16. The method of claim 15, wherein the uploading to the backend server is performed automatically by the second road user.

17. The method of claim 16, further comprising deleting, by the second road user, the information associated with the detected event after the information has been successfully uploaded to the backend server or after a predetermined period of time has elapsed since detection of the event or reception of the R2X or I2R direct communication signal.

18. The method of claim 17, wherein the R2X or the I2R direct communication signal comprises a Decentralized Environmental Notification Message associated with the detected event.

19. The method of claim 18, wherein the second road user broadcasts a second R2X direct communication signal comprising a cooperative awareness message indicating a presence of the second road user to surrounding road users or road infrastructures, and wherein the road infrastructure or the first road user receives the second R2X direct communication signal and broadcasts or repeatedly broadcasts the R2X or the I2R direct communication signal comprising the information associated with the detected event in response to the second R2X direct communication signal.

20. A non-transitory computer-readable storage medium comprising instructions that, when executed by at least one processor, cause the processor to perform a method comprising:
detecting an event concerning a threat to road safety based on sensor data representative of an environment of a road infrastructure or a first road user;
broadcasting a road user-to-Everything direct communication signal and/or an infrastructure-to-road-user direct communication signal comprising information associated with the detected event;
receiving, by a second road user, the direct communication signal comprising the information associated with the detected event;
uploading, by the second road user, at least a part of the information associated with the detected event to a backend server;
downloading, by a third road user, at least the part of the information associated with the detected event from the backend server;
determining, by the third road user, a relevance of the detected event for the third road user based on the information associated with the detected event; and
outputting the determined relevance and/or preparing a countermeasure based on the determined relevance of the detected event.
